(19) United States
(12) Patent Application Publication
(10) Pub. No.: US 2016/0090755 A1
(43) Pub. Date: Mar. 31, 2016

(54) SECURING DEVICE FOR AN ELECTRONIC DEVICE

(71) Applicant: ABA UFO INTERNATIONAL CORP., New Taipei City (TW)

(72) Inventor: Miko LEE, New Taipei City (TW)

(73) Assignee: ABA UFO INTERNATIONAL CORP., New Taipei City (TW)

(21) Appl. No.: 14/502,185

(22) Filed: Sep. 30, 2014

(51) Int. Cl. E05B 73/00

(52) U.S. Cl. CPC E05B 73/0082; E05B 73/0005

(57) ABSTRACT

A securing device for an electronic device has a holding assembly with a holding seat and a sucker, a rope connected to the holding seat, and a lock and a pressing element mounted on the holding seat. When the securing device is in use, the rope is looped around a post and a side or a corner of the electronic device is mounted between the pressing element and the sucker. Then, a key drives a lock core of the lock to drive the pressing element, such that the electronic device is tightly held between the pressing element and the sucker. Accordingly, the electronic device can be secured at a specific position. The securing device can be used on the electronic devices of different shapes and sizes and is convenient for manufacturing, purchasing, and using.

### BACKGROUND OF THE INVENTION

1. Field of the Invention

The present invention relates to a securing device for an electronic device, especially to a securing device that secures the electronic device at a specific position.

2. Description of the Prior Art(s)

With development of electronic industry, a portable electronic device, such as a mobile phone, a tablet computer and the like, has various functions and light and thin shape to allow a user to carry around for use at any occasion. However, when using the portable electronic device in public places, such as a coffee shop, library and the like, the user might want to leave the portable electronic device in his seat while the user goes for ordering or taking a meal or for toilet. The portable electronic device is stolen easily when being left behind.

In order to prevent the electronic device from being stolen in the public places, a conventional securing device for securing the electronic device at a specific position comprises a holding bracket and a lock. The holding bracket holds around a peripheral edge of the electronic device. The lock is securely mounted on the holding bracket and is connected with a rope. The rope can be looped around a post, such as a leg of a table, so the electronic device cannot be taken away from the post and stolen. However, since the conventional securing device is mounted on the electronic device by holding around the peripheral edge of the electronic device, manufacturers have to manufacture the holding brackets in different sizes for fitting the electronic devices having different sizes. Accordingly, the users have to choose one conventional securing device that is suitable for his electronic device. The conventional securing devices are inconvenient for manufacturing, purchasing, and using.

To overcome the shortcomings, the present invention provides a securing device for an electronic device to mitigate or obviate the aforementioned problems.

### SUMMARY OF THE INVENTION

The main objective of the present invention is to provide a securing device for an electronic device. The securing device has a holding assembly, a rope, a lock, and a pressing element. The holding assembly has a holding seat and a sucker mounted on the holding seat. The rope is connected to the holding seat. The lock and the pressing element are mounted on the holding seat.

When using the securing device, the rope is looped around a post, and a side or a corner of the electronic device is mounted between the pressing element and the sucker. Then, a key drives a lock core of the lock to drive the pressing element, such that the electronic device is tightly held between the pressing element and the sucker. Accordingly, the electronic device can be secured at a specific position. The securing device can be used on the electronic devices of different shapes and sizes and is convenient for manufacturing, purchasing, and using.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a securing device for an electronic device in accordance with the present invention;

FIG. 2 is an exploded perspective view of the securing device in FIG. 1;

FIG. 3 is an exploded perspective view of a lock and a pressing element of the securing device in FIG. 1;

FIG. 4 is a bottom view of the securing device in FIG. 1;

FIG. 5 is a cross-sectional side view of the securing device in FIG. 1, showing the electronic device inserted in the securing device;

FIG. 6 is a cross-sectional side view of the securing device in FIG. 1, showing the electronic device held by the securing device; and

FIG. 7 is a cross-sectional top view of the lock of the securing device in FIG. 1.

### DETAILED DESCRIPTION OF THE PREFERRED EMBODIMENTS

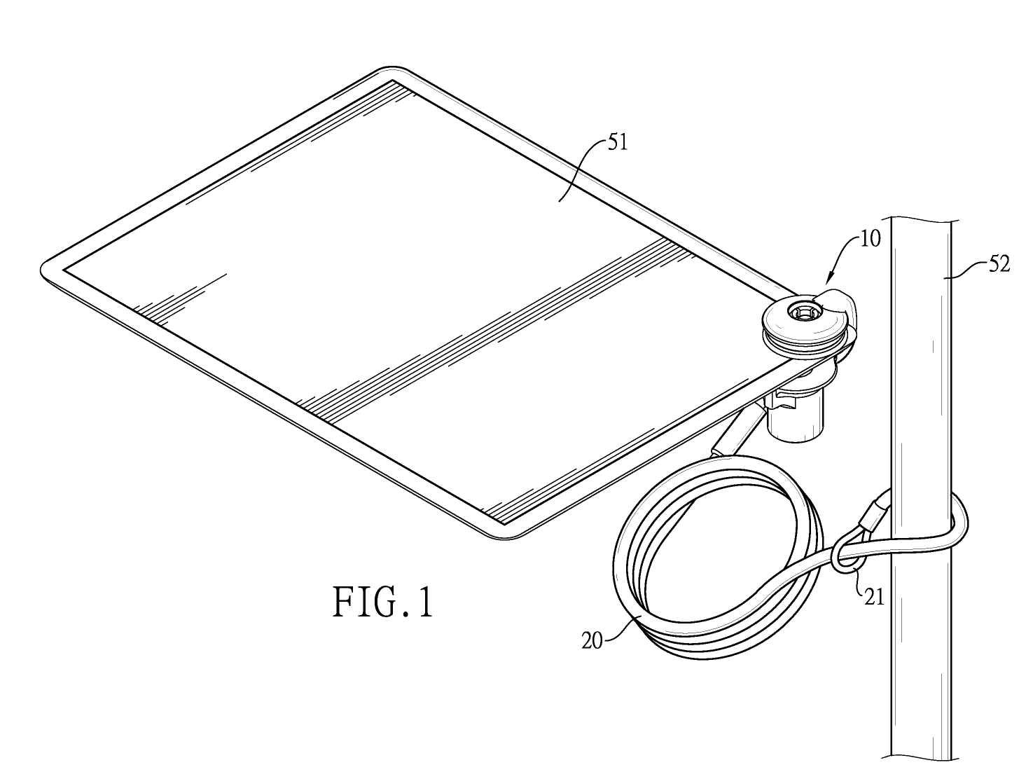

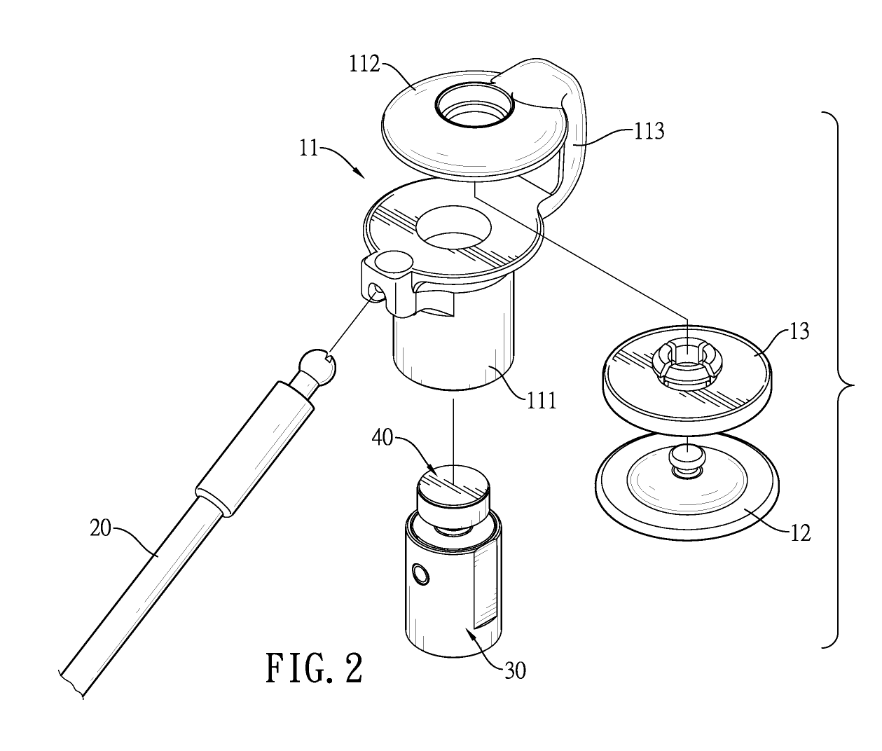

With reference to FIGS. 1, 2, and 5, a securing device for an electronic device in accordance with the present invention comprises a holding assembly 10, a rope 20, a lock 30, an outer fastening pin 36, and a pressing element 40.

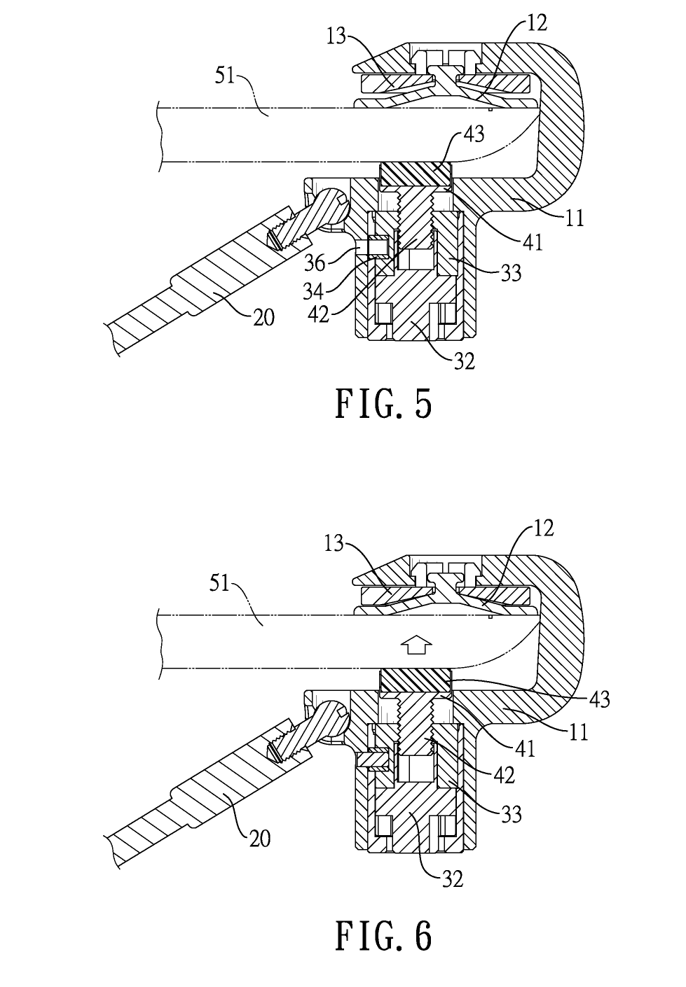

As shown in FIG. 5, the holding assembly 10 has a holding seat 11 and a sucker 12. The holding seat 11 has a base 111 and a stationary panel 112. The base 111 is hollow and has an upper opening and a lower opening. The upper opening of the base 111 is formed on an upper surface of the base 111. The lower opening of the base 111 is formed on a lower surface of the base 111. The stationary panel 112 is disposed above the upper surface of the base 111 and is connected to the base 111 via a side arm 113. The stationary panel 112 has a lower surface facing the base 111. The sucker 12 is securely mounted on the lower surface of the stationary panel 112 of the holding seat 11.

In the preferred embodiment, the holding assembly 10 further has an upper panel 13. The upper panel 13 is securely mounted on the lower surface of the stationary panel 112 of the holding seat 11. The sucker 12 is mounted on the upper panel 13. Thus the sucker 12 is securely mounted on the lower surface of the stationary panel 112 of the holding seat 11 via the upper panel 13.

The rope 20 has a distal end, a proximal end, and a lasso 21. The proximal end of the rope 20 is connected to the holding seat 11. The lasso 21 is formed on the distal end of the rope 20.

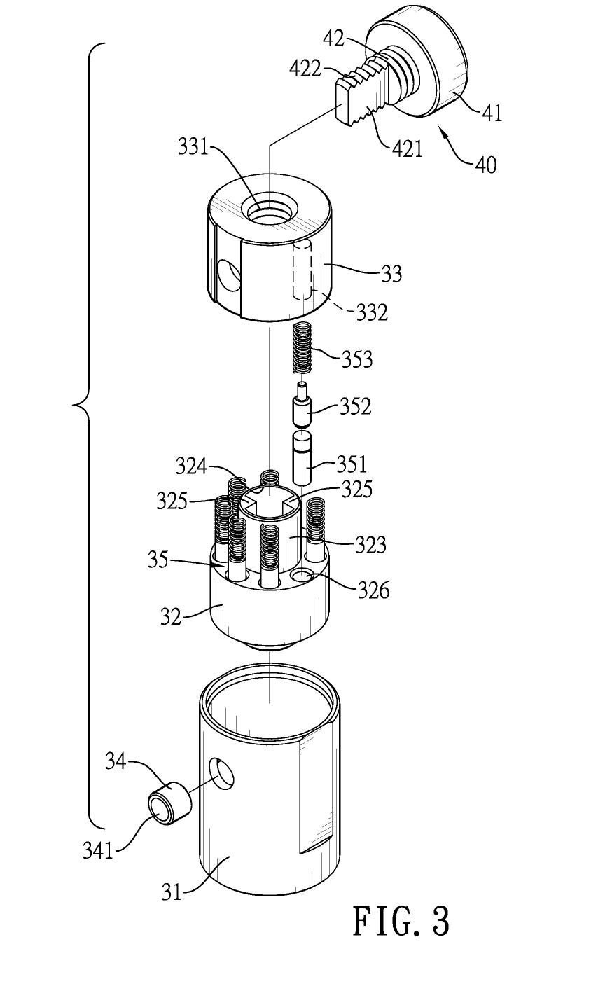

With further reference to FIG. 3, the lock 30 is mounted in the base 111 of the holding seat 11 and has a housing 31, a lock core 32, an upper pin seat 33, an inner fastening pin 34, and multiple pin sets 35.

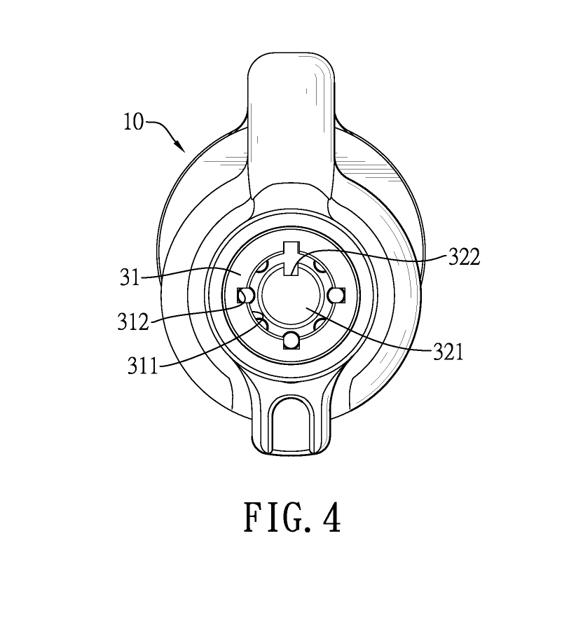

With further reference to FIG. 4, t he housing 31 is securely mounted in the base 111 of the holding seat 11 and has a lower end surface, a keyhole 311, an inner edge, and multiple outer positioning recesses 312. The lower end surface of the housing 31 corresponds in position to the lower surface of the base 111. The keyhole 311 is formed through the lower end surface of the housing 31. The inner edge of the housing 31 is defined around the keyhole 311. The outer positioning recesses 311 are separately formed radially in the inner edge of the housing 31.

The lock core 32 is rotatably mounted in the housing 31 and is disposed adjacent to the lower opening of the base 111. The lock core 32 has a lower mounting portion 321, an upper mounting portion 323, and multiple lower pin recesses 326.

The lower mounting portion 321 axially protrudes down from a lower end surface of the lock core 32 and extends toward the lower opening of the base 111. The lower mounting portion 321 has a distal end surface, an outer side surface, and an inner positioning recess 322. The inner positioning recess 322 is radially formed in the outer side surface of the lower mounting portion 321 and through the distal end surface of the lower mounting portion 321.

The upper mounting portion 323 axially protrudes up from an upper end surface of the lock core 32 and extends toward the upper opening of the base 111. The upper mounting portion 323 has a distal end surface, a driving recess 324, an inner side surface, and two limiting protrusions 325. The driving recess 324 is axially formed in the distal end surface of the upper mounting portion 323. The inner side surface of the upper mounting portion 323 is defined around the driving recess 324. The limiting protrusions 325 are separately formed on the inner side surface of the upper mounting portion 323 and are opposite to each other. An angular distance defined between the limiting protrusions 325 is larger than an angular distance defined between two of the outer positioning recesses 312 that are disposed next to each other.

The lower pin recesses 326 are formed between and through the upper end surface of the lock core 32 and the lower end surface of the lock core 32, and are arranged around the lower mounting portion 321 and the upper mounting portion 323.

In the preferred embodiment, the housing 31 has four outer positioning recesses 312 spaced 90 degrees apart. The angular distance defined between the limiting protrusions 325 of the lock core 32 is 90 degrees or above.

The upper pin seat 33 is mounted around the upper mounting portion 323 of the lock core 32 and is non-rotatably mounted in the housing 31. The upper pin seat 33 has a threaded hole 331 and multiple upper pin recesses 332. The threaded hole 331 is formed in an upper end surface of the upper pin seat 33 and aligns with the driving recess 324 of the lock core 32. The upper pin recesses 332 are formed between and through the upper end surface of the upper pin seat 33 and a lower end surface of the upper pin seat 33, are arranged around the threaded hole 331, and respectively align with the lower pin recesses 326 of the lock core 32.

The inner fastening pin 34 is radially mounted through the housing 31 and the upper pin seat 33 and has a through hole 341. The through hole 341 is formed between and through two opposite ends of the inner fastening pin 34. Thus, the housing 31 and the upper pin seat 33 do not rotate relative to each other.

The pin sets 35 are mounted in the lower pin recesses 326 of the lock core 32 and the upper pin recesses 332 of the upper pin seat 33. Each of the pin sets 35 has a lower pin 351, an upper pin 352, and a resilient element 353. The lower pin 351 is slidably mounted in a corresponding one of the lower pin recesses 326 of the lock core 32 and has an upper end. The upper pin 352 is slidably mounted in a corresponding one of the upper pin recesses 332 of the upper pin seat 33 and has an upper end and a lower end. The lower end of the upper pin 352 abuts the upper end of the lower pin 351. The resilient element 353 is mounted on the upper end of the upper pin 352 and has two opposite ends respectively abutting the upper pin 352 and the upper pin seat 33. Since the upper pin seat 33 is fixed in the housing 31, the resilient elements 353 push the upper pins 352 and the lower pins 351 to slide toward the lower end surface of the lock core 32.

The outer fastening pin 36 is mounted through the base 111 of the holding seat 11 and is securely mounted in the through hole 341 of the inner fastening pin 34, such that the lock 30 is securely mounted in the base 111 of the holding seat 11.

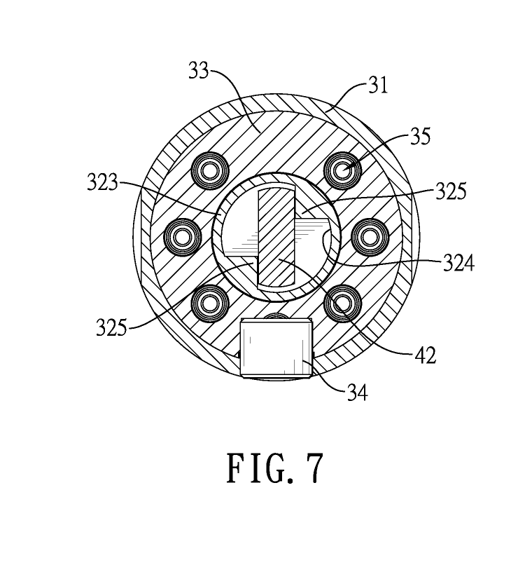

With further reference to FIG. 7, the pressing element 40 has a pressing head 41, a screw 42, and a cushion 43. The pressing head 41 is mounted in the upper opening of the base 111 of the holding seat 11, and faces and is apart from the sucker 12. The screw 42 protrudes down from a lower surface of the pressing head 41, is mounted through the threaded hole 331 of the upper pin seat 33, engages with the upper pin seat 33, and protrudes into the driving recess 324 of the lock core 32. The screw 42 has two opposite flat surfaces 421 and two opposite threaded surfaces 422. The flat surfaces 421 and the threaded surfaces 422 are arranged alternately around the screw 42. The flat surfaces 421 selectively and respectively abut the limiting protrusions 325 of the lock core 32. The threaded surfaces 422 engage with the upper pin seat 33 in the threaded hole 331 of the upper pin seat 33. Thus, when the pressing element 40 rotates, the pressing element 40 selectively moves longitudinally up and down relative to the lock 30. The cushion 43 is securely mounted on an upper surface of the pressing head 41. In the preferred embodiment, the cushion 43 is embedded in the upper surface of the pressing head 41. Alternatively, the cushion 43 may be adhered to the upper surface of the pressing head 41.

With reference to FIG. 5, to use the securing device, the rope 20 is looped around a post 52, and the holding seat 11 is mounted through the lasso 21 of the rope 20. Then an electronic device 51 is mounted between the pressing head 41 of the pressing element 40 and the sucker 12.

With further reference to FIGS. 4, 6, and 7, afterwards, a key is inserted through the keyhole 311 of the housing 31 to drive the lock core 32. The limiting protrusions 325 in the driving recess 324 of the upper mounting portion 323 of the lock core 32 push the pressing element 40 to rotate. Thus, the pressing element 40 moves upward to shorten a distance between the sucker 12 and the pressing head 41 of the pressing element 40. Accordingly, the electronic device 51 is held between the sucker 12 and the pressing head 41 of the pressing element 40. The cushion 43 on the upper surface of the pressing head 41 abuts the electronic device and prevents the electronic device 51 from being damaged.

In the preferred embodiment, the key is a tubular key and has a driving tube. The driving tube can be inserted between the housing 31 and the lower mounting portion 321 of the lock core 32, and has an outer boss and an inner boss. The outer boss is formed on an outer surface of the driving tube. The inner boss is formed on an inner surface of the driving tube. When inserting the driving tube of the key into the keyhole 311 of the housing 31, the outer boss is inserted into one of the outer positioning recesses 312 and the inner boss is inserted into the inner positioning recess 322 of the lock core 32. Thus, the key can drive the lock core 32 to rotate. With the multiple outer positioning recesses 312 formed around the keyhole 311 of the housing 31, when the key drives the key core 32 and the pressing element 40 to tightly hold the electronic device 51, the key can reverse to a nearest one of the outer positioning recesses 312 so as to exit from the lock 30. Since the key does not have to be inserted or pulled out through the same outer positioning recess 312, the pressing element 40 and the sucker 12 can keep holding the electronic device 51 tightly.

The securing device as described has the following advantages. Since the securing device only needs to hold one side or one corner of the electronic device 51, the securing device can be used on the electronic devices 51 of different shapes and sizes. Each of the securing devices is not only suitable for one kind of electronic device 51. Consequently, the securing device is convenient for manufacturing, purchasing, and using.

Even though numerous characteristics and advantages of the present invention have been set forth in the foregoing description, together with details of the structure and features of the invention, the disclosure is illustrative only.

Changes may be made in the details, especially in matters of shape, size, and arrangement of parts within the principles of the invention to the full extent 6indicated by the broad general meaning of the terms in which the appended claims are expressed.

What is claimed is:

1. A securing device for an electronic device comprising:
a holding assembly having
a holding seat having
a base being hollow and having an upper opening and a lower opening; and
a stationary panel disposed above an upper surface of the base and having a lower surface facing the base; and
a sucker securely mounted on the lower surface of the stationary panel of the holding seat;
a rope having
a distal end;
a proximal end connected to the holding seat; and
a lasso formed on the distal end of the rope;
a lock mounted in the base of the holding seat and having
a housing securely mounted in the base of the holding seat;
a lock core rotatably mounted in the housing and having an upper mounting portion, the upper mounting portion protruding up from an upper end surface of the lock core and having
a distal end surface;
a driving recess formed in the distal end surface of the upper mounting portion;
an inner side surface defined around the driving recess; and
two limiting protrusions separately formed on the inner side surface of the upper mounting portion; and
an upper pin seat mounted around the upper mounting portion of the lock core and non-rotatably mounted in the housing, the upper pin seat having a threaded hole, the threaded hole formed in an upper end surface of the upper pin seat and aligning with the driving recess of the lock core; and
a pressing element having
a pressing head mounted in the upper opening of the base of the holding seat, and facing and being apart from the sucker; and
a screw protruding down from a lower surface of the pressing head, mounted through the threaded hole of the upper pin seat, engaging with the upper pin seat, and protruding into the driving recess of the lock core, the screw having two opposite flat surfaces and two opposite threaded surfaces, the flat surfaces and the threaded surfaces arranged alternately around the screw, the flat surfaces selectively and respectively abutting the limiting protrusions of the lock core, and the threaded surfaces engaging with the upper pin seat in the threaded hole of the upper pin seat.

2. The securing device as claimed in claim 1, wherein
the housing of the lock has
a lower end surface;
a keyhole formed through the lower end surface of the housing;
an inner edge defined around the keyhole; and
multiple outer positioning recesses separately formed radially in the inner edge of the housing;
the lock core of the lock further has a lower mounting portion protruding down from a lower end surface of the lock core and having an inner positioning recess radially formed in an outer side surface of the lower mounting portion and through a distal end surface of the lower mounting portion; and
an angular distance defined between the limiting protrusions is larger than an angular distance defined between two of the outer positioning recesses that are disposed next to each other.

3. The securing device as claimed in claim 1, wherein the lock core further has multiple lower pin recesses formed between and through the upper end surface of the lock core and a lower end surface of the lock core, and arranged around the upper mounting portion;
the upper pin seat further has multiple upper pin recesses formed between and through the upper end surface of the upper pin seat and a lower end surface of the upper pin seat, and respectively aligning with the lower pin recesses of the lock core; and
the lock further has multiple pin sets mounted in the lower pin recesses of the lock core and the upper pin recesses of the upper pin seat, each of the pin sets has
a lower pin slidably mounted in a corresponding one of the lower pin recesses of the lock core and having an upper end;
an upper pin slidably mounted in a corresponding one of the upper pin recesses of the upper pin seat and having an upper end and a lower end abutting the upper end of the lower pin; and
a resilient element mounted on the upper end of the upper pin and having two opposite ends respectively abutting the upper pin and the upper pin seat.

4. The securing device as claimed in claim 2, wherein
the lock core further has multiple lower pin recesses formed between and through the upper end surface of the lock core and the lower end surface of the lock core, and arranged around the upper mounting portion;
the upper pin seat further has multiple upper pin recesses formed between and through the upper end surface of the upper pin seat and a lower end surface of the upper pin seat, and respectively aligning with the lower pin recesses of the lock core; and
the lock further has multiple pin sets mounted in the lower pin recesses of the lock core and the upper pin recesses of the upper pin seat, each of the pin sets has
a lower pin slidably mounted in a corresponding one of the lower pin recesses of the lock core and having an upper end;
an upper pin slidably mounted in a corresponding one of the upper pin recesses of the upper pin seat and having an upper end and a lower end abutting the upper end of the lower pin; and
a resilient element mounted on the upper end of the upper pin and having two opposite ends respectively abutting the upper pin and the upper pin seat.

5. The securing device as claimed in claim 1, wherein the pressing element further has a cushion securely mounted on an upper surface of the pressing head.

6. The securing device as claimed in claim 2, wherein the pressing element further has a cushion securely mounted on an upper surface of the pressing head.

7. The securing device as claimed in claim 3, wherein the pressing element further has a cushion securely mounted on an upper surface of the pressing head.

8. The securing device as claimed in claim 4, wherein the pressing element further has a cushion securely mounted on an upper surface of the pressing head.

9. The securing device as claimed in claim 5, wherein
the lock further has an inner fastening pin radially mounted through the housing and the upper pin seat and having a through hole formed between and through two opposite ends of the inner fastening pin; and
the securing device further has an outer fastening pin mounted through the base of the holding seat and securely mounted in the through hole of the inner fastening pin.

10. The securing device as claimed in claim 6, wherein
the lock further has an inner fastening pin radially mounted through the housing and the upper pin seat and having a through hole formed between and through two opposite ends of the inner fastening pin; and
the securing device further has an outer fastening pin mounted through the base of the holding seat and securely mounted in the through hole of the inner fastening pin.

11. The securing device as claimed in claim 7, wherein
the lock further has an inner fastening pin radially mounted through the housing and the upper pin seat and having a through hole formed between and through two opposite ends of the inner fastening pin; and
the securing device further has an outer fastening pin mounted through the base of the holding seat and securely mounted in the through hole of the inner fastening pin.

12. The securing device as claimed in claim 8, wherein
the lock further has an inner fastening pin radially mounted through the housing and the upper pin seat and having a through hole formed between and through two opposite ends of the inner fastening pin; and
the securing device further has an outer fastening pin mounted through the base of the holding seat and securely mounted in the through hole of the inner fastening pin.

13. The securing device as claimed in claim 9, wherein
the holding assembly further has an upper panel securely mounted on the lower surface of the stationary panel of the holding seat; and
the sucker is mounted on the upper panel.

14. The securing device as claimed in claim 10, wherein the holding assembly further has an upper panel securely mounted on the lower surface of the stationary panel of the holding seat; and
the sucker is mounted on the upper panel.

15. The securing device as claimed in claim 11, wherein
the holding assembly further has an upper panel securely mounted on the lower surface of the stationary panel of the holding seat; and
the sucker is mounted on the upper panel.

16. The securing device as claimed in claim 12, wherein
the holding assembly further has an upper panel securely mounted on the lower surface of the stationary panel of the holding seat; and
the sucker is mounted on the upper panel.

17. The securing device as claimed in claim 13, wherein
the housing has four outer positioning recesses spaced 90 degrees apart; and
the angular distance defined between the limiting protrusions of the lock core is 90 degrees or above.

18. The securing device as claimed in claim 14, wherein
the housing has four outer positioning recesses spaced 90 degrees apart; and
the angular distance defined between the limiting protrusions of the lock core is 90 degrees or above.

19. The securing device as claimed in claim 15, wherein
the housing has four outer positioning recesses spaced 90 degrees apart; and
the angular distance defined between the limiting protrusions of the lock core is 90 degrees or above.

20. The securing device as claimed in claim 16, wherein
the housing has four outer positioning recesses spaced 90 degrees apart; and
the angular distance defined between the limiting protrusions of the lock core is 90 degrees or above.
